(19) United States
(12) Patent Application Publication
(10) Pub. No.: US 2015/0270075 A1
(43) Pub. Date: Sep. 24, 2015

(54) MODULAR GAS EXHAUST ASSEMBLY FOR A CIRCUIT BREAKER

(71) Applicant: General Electric Company, Schenectady, NY (US)

(72) Inventors: Saugata Das, Hyderabad (IN); Triplicane Gopikrishnan Babu, Hyderabad (IN); Anurag Arjundas Jivanani, Plainville, CT (US); Roger John Morgan, Plainville, CT (US)

(73) Assignee: General Electric Company, Schenectady, NY (US)

(21) Appl. No.: 14/221,708

(22) Filed: Mar. 21, 2014

(51) Int. Cl. H01H 9/34

(52) U.S. Cl. CPC H01H 9/342

(57) ABSTRACT

A modular gas exhaust assembly for a circuit breaker having a plurality of arc chutes, each having an associated expulsion location. The modular gas exhaust assembly includes a plurality of modular exhaust casings. Also included is a plurality of gas channels, each channel defined by one of the plurality of modular exhaust casings, the plurality of modular exhaust casings each configured to be removably coupled to at least one of the arc chute expulsion locations of the plurality of arc chutes, wherein the number of the plurality of gas channels is equal to the number of a plurality of poles of the circuit breaker, each gas channel aligned with a respective pole and configured to separately exhaust arc gases from the respective pole of the circuit breaker.

### BACKGROUND OF THE INVENTION

The subject matter disclosed herein relates to circuit breaker assemblies and, more particularly, to a modular gas exhaust assembly for arc gases generated by such circuit breaker assemblies.

An electrical switching apparatus, such as a circuit breaker, provides protection for electrical systems from electrical fault conditions such as, for example, current overloads, short circuits, abnormal voltage and other fault conditions. Typically, circuit breakers include a housing and an operating mechanism which opens separable electrical contacts to interrupt the flow of current through the conductors of an electrical system in response to certain fault conditions.

Some circuit breakers have arc chute vents on a portion, such as a top portion, of the housing. When the separable electrical contacts rapidly open in response to an overload or short circuit condition, an arc is created which generates gases that are expelled through the vents. The gases can be extremely hot, are at least partly ionized, and may carry debris, such as molten metal particles. Further, the gases and debris can be electrically conductive and may cause additional undesirable arcing between the circuit breaker and grounded electrically conductive features proximate the circuit breaker including, but not limited to, the metallic enclosure in which such circuit breakers are typically installed. The gases may also be expelled with explosive force and may damage components of the enclosure.

Due to the potential undesirable conditions described above, switchgear enclosures are typically designed to include one or more channels in which arc gases can be directed for dissipation thereof Some switchgear enclosures also include an insulated barrier, commonly referred to as an arc hood, which is mounted above the arc chute vents of the circuit breaker through which the arc gases are exhausted. The arc hood functions to manage the effects of the arc gases and to cool and dissipate the arc gases within the arc hood. However, limitations of prior exhaust assemblies are present and often result in less than optimal dielectric behavior of the circuit breaker and may be prone to ground fuse failure during a fault event. These limitations hinder the ability of circuit breakers to be upgraded in short circuit rating, for example.

### BRIEF DESCRIPTION OF THE INVENTION

According to one aspect of the invention, a modular gas exhaust assembly for a circuit breaker having a plurality of arc chutes, each having an associated expulsion location. The modular gas exhaust assembly includes a plurality of modular exhaust casings. Also included is a plurality of gas channels, each channel defined by one of the plurality of modular exhaust casings, the plurality of modular exhaust casings each configured to be removably coupled to at least one of the arc chute expulsion locations of the plurality of arc chutes, wherein the number of the plurality of gas channels is equal to the number of a plurality of poles of the circuit breaker, each gas channel aligned with a respective pole and configured to separately exhaust arc gases from the respective pole of the circuit breaker.

According to another aspect of the invention, a circuit breaker assembly includes a circuit breaker and a plurality of arc chutes defined by the circuit breaker, each of the plurality of arc chutes aligned with a pole of the circuit breaker and having an expulsion location to exhaust an arc gas from the circuit breaker. Also included is a plurality of modular exhaust casings. Further included is a plurality of gas channels, each channel defined by one of the plurality of modular exhaust casings, each of the plurality of modular exhaust casings configured to be removably coupled proximate the expulsion location of at least one of the plurality of arc chutes, each of the plurality of gas channels aligned with a respective pole of the circuit breaker and having an exhaust outlet side to separately exhaust arc gases from the respective pole of the circuit breaker. Yet further included is a plurality of filter plates having a plurality of apertures and aligned perpendicularly to a gas flow direction, wherein each of the plurality of filter plates are disposed proximate the exhaust outlet side of each of the plurality of gas channels.

According to yet another aspect of the invention, a method of exhausting an arc gas from a circuit breaker is provided. The method includes extending a protected interior volume of the circuit breaker with a plurality of modular exhaust casings located proximate an expulsion location of at least one arc chute. The method also includes allowing additional cooling and de-ionization of the arc gas within a plurality of gas channels defined by the plurality of modular exhaust casings.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a circuit breaker assembly having a modular gas exhaust assembly mounted thereto;

FIG. 2 is a cross-sectional view of the circuit breaker assembly and modular gas exhaust assembly;

FIG. 3 is a perspective view of a gas channel of the modular gas exhaust assembly according to one aspect of the invention; and

FIG. 4 is a perspective view of the gas channel of the modular gas exhaust assembly according to another aspect of the invention.

The detailed description explains embodiments of the invention, together with advantages and features, by way of example with reference to the drawings.

### DETAILED DESCRIPTION OF THE INVENTION

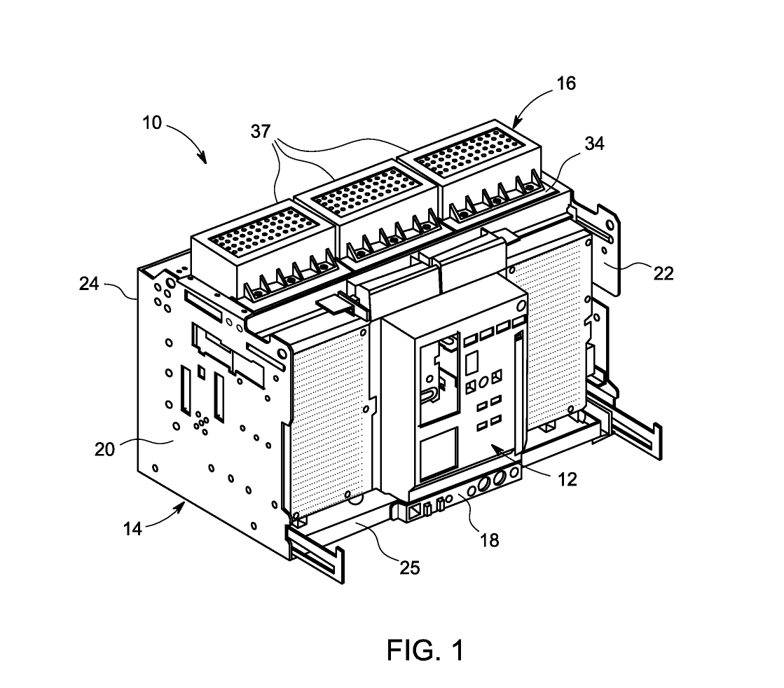

Referring to FIG. 1, a circuit breaker assembly 10 is illustrated. In particular, a circuit breaker 12, a circuit breaker cassette 14 and a modular gas exhaust assembly 16 are generally shown. In the illustrated embodiment, the circuit breaker 12 is a draw out air circuit breaker, but it is to be appreciated that alternative circuit breaker types may be employed with the embodiments of the modular gas exhaust assembly 16 described herein.

The circuit breaker cassette 14 is configured to receive the circuit breaker 12 in a sliding manner to be at least partially disposed within the circuit breaker cassette 14. The circuit breaker cassette 14 includes a cassette front panel 18 and an associated draw out support plate configured to contact and facilitate support and sliding of the circuit breaker 12. The circuit breaker cassette 14 includes a first sidewall 20, a second sidewall 22, a rear wall 24, and a base wall 25, which in combination houses the circuit breaker 12.

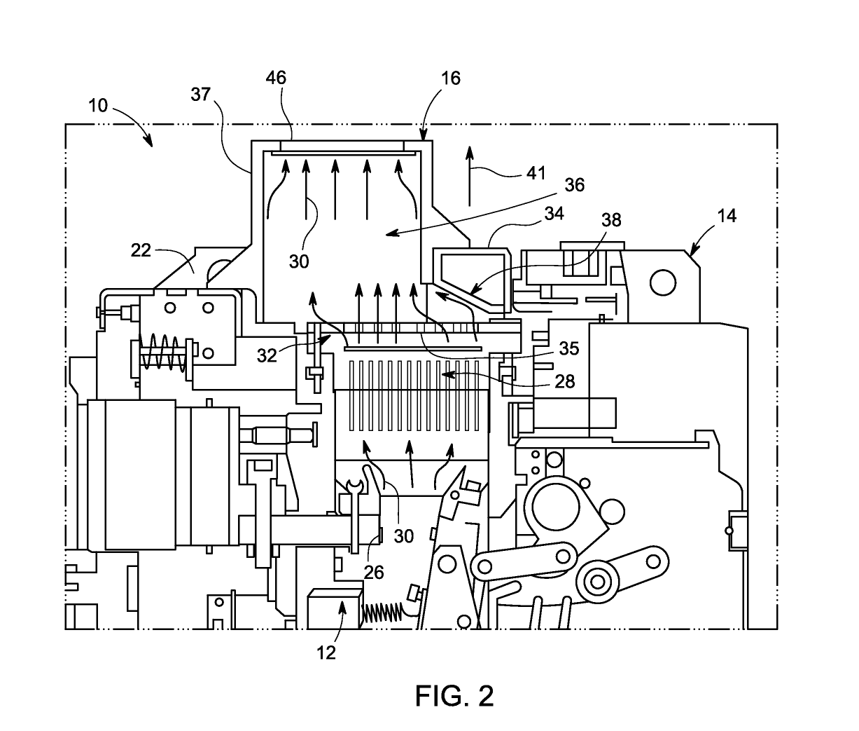

Referring to FIG. 2, a cross-sectional view of the circuit breaker assembly 10 is shown. The circuit breaker 12 includes a plurality of contacts configured for connecting and disconnecting an electrical power source to an electrical load. The circuit breaker 12 includes a plurality of conductors, with one such conductor referenced with numeral 26. The conductors are configured to be connected to an electrical circuit (not illustrated in detail). When in a drawn out position, the circuit breaker 12 is on the draw out support plate 18 and is moved in and out of connection with the electrical circuit. The conductors allow current to flow through the circuit breaker 12 and to be transmitted to the electrical circuit and load.

The circuit breaker 12 includes one or more arc chutes 28 for each pole of the circuit breaker 12. In the illustrated embodiment, a single arc chute is depicted due to the cross-sectional nature of the figure, but it can be appreciated that any number of multi-pole circuit breakers may be included, thereby forming a plurality of arc chutes. For example, the illustrated embodiment of FIG. 1 shows a three-phase circuit breaker with a three-pole arrangement. Additionally, a four-phase embodiment may be employed with a pole corresponding to a ground line.

Irrespective of the precise number of poles/phases of the circuit breaker 12, magnetic repulsion forces are created by high currents running in parallel in each current path of each pole of the circuit breaker 12 in response to a circuit fault, such as a short circuit trip event. In response to such a trip event, an arc may be generated between contacts as movable contacts are separated from fixed contacts. The arc chute 28 is configured to extinguish arcs that may be created during such an event. Associated with generation of the arc is a production of heat that causes an expansion of arc gases 30 surrounding the arc proximate the contacts. The arc gases 30 begin proximate the contacts and continue through the arc chute 28 toward an upper portion 32 of the circuit breaker cassette 14 to be exhausted out of the circuit breaker assembly 10.

Referring again to FIG. 1, with continued reference to FIG. 2, the modular gas exhaust assembly 16 is operatively coupled to a mounting plate 34 that is fixed to the circuit breaker cassette 14 proximate the upper portion 32 of the arc chute(s) 28. A plurality of holes 35 defined by the upper portion 32 of the circuit breaker cassette 14 are configured to allow routing of the arc gases 30 to an interior region, referred to herein as a gas channel, of the modular gas exhaust assembly 16. Although illustrated and described above as being removably coupled to the mounting plate 34, it is to be understood that the modular gas exhaust assembly 16 may be directly or indirectly coupled in a repeatedly removable manner to the circuit breaker 12 in any manner that disposes a plurality of gas channels 36 of the modular gas exhaust assembly 16 into a position that facilitates direct routing of the arc gases 30 from the arc chutes 28 to the plurality of gas channels 36. In particular, the arc gases 30 are routed to at least one, but typically a plurality of gas channels 36 of the modular gas exhaust assembly 16. The number of the plurality of gas channels 36 corresponds to (i.e., equal to) the number of poles of the circuit breaker 12, as described above in detail. In the illustrated embodiment, three gas channels are shown. The plurality of gas channels 36 are defined by at least one, but typically a plurality of modular exhaust casings 37. The plurality of modular exhaust casings 37 may be of any geometric configuration. In the illustrated embodiment, the casings are formed in a substantially rectangular shape, however, it is to be appreciated that any suitable alternative geometry may be employed.

Each of the plurality of modular exhaust casings 37 of the modular gas exhaust assembly 16 is removably mounted to the mounting plate 34 in a manner that allows an operator to easily mount and remove the plurality of modular exhaust casings 37 to the mounting plate 34. In one embodiment, mechanical fasteners, such as screws, bolts or the like are employed to repeatedly mount and remove the plurality of modular exhaust casings 37. Mounting in this manner facilitates the ability to repeatedly reconfigure the modular gas exhaust assembly 16 to customize the number of the plurality of gas channels 36 to correspond to the number of poles of the circuit breaker 12.

The modular gas exhaust assembly 16 and, more specifically, the plurality of gas channels 36 effectively increase the space provided for the arc gases 30 to cool and de-ionize before final exhausting to the atmosphere surrounding the exterior of the circuit breaker assembly 10. Additionally, as described above, the number of the plurality of gas channels 36 can be adjusted, as needed, due to the repeatedly removable mounting assembly of the plurality of gas channels 36 to the mounting plate 34 or any other mounting structure proximate the arc chute(s) 28 of the circuit breaker 12.

Each of the plurality of gas channels 36 is insulated from each other to channel the arc gas for a respective pole of the circuit breaker 12 during a circuit trip event, thereby separating the arc gases 30, which have different electric potential for each respective ionized gas in the individual phases. This advantageously reduces the likelihood of a ground fault during a short circuit event. The arc gases 30 are routed through the arc chute 28 and toward the upper portion 32 of the arc chute(s) 28. The mounting plate 34 fixed to the circuit breaker cassette 14 includes a deflector portion 38 configured to redirect the arc gases 30 toward the respective gas channel of the modular gas exhaust assembly 16.

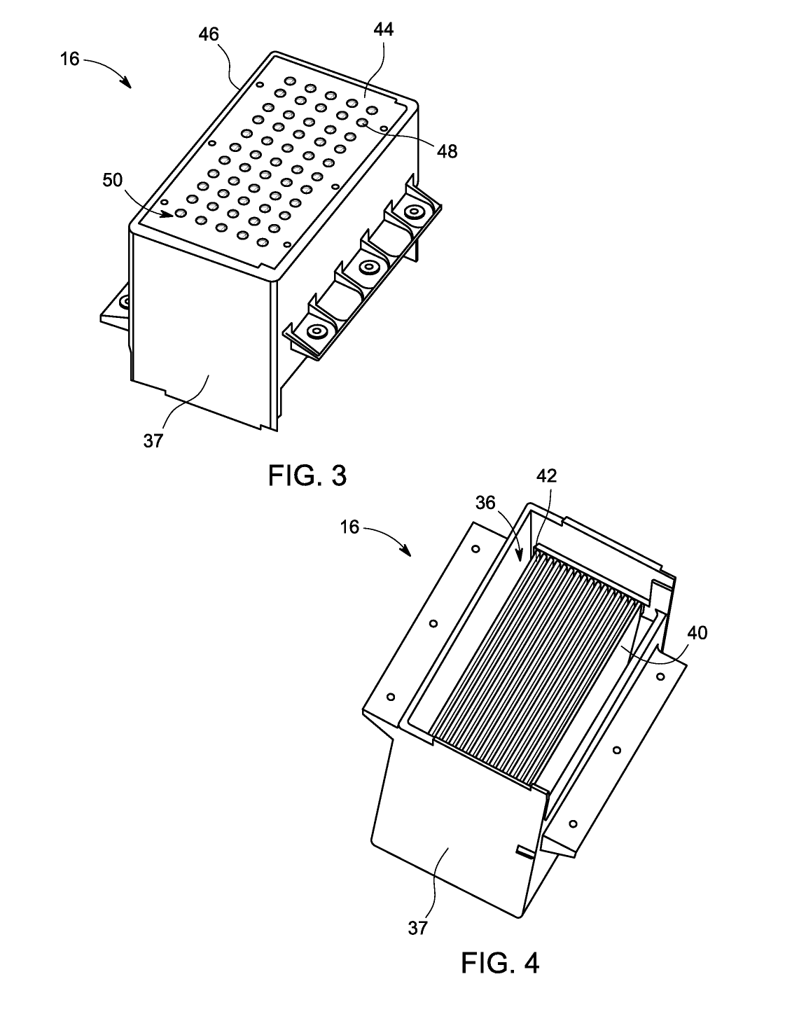

Referring now to FIGS. 3 and 4, one of the plurality of gas channels 36 of the modular gas exhaust assembly 16 is shown in greater detail. The gas channel includes at least one type of plate disposed within the interior portion of the gas channel to enhance heat dissipation from the arc gases 30 and to remove the electrical potential from them via heat dispersion. The plate(s) may be formed of the same or distinct materials, but are typically formed of a metallic material. Two types of plates will be described in detail below. It is to be appreciated that the types of plates may be used independently of the other type or in combination with each other.

A first type of plate (FIG. 4) within the gas channel comprises a plurality of plates 40 that are aligned in a substantially parallel orientation relative to the predominant flow direction 41 (FIG. 2) of the arc gases 30. The plurality of plates 40 define a plurality of gas flow passages 42 therebetween, with each pair of adjacent plates defining a single gas flow passage. The number of the plurality of plates 40 and corresponding number of the plurality of gas flow passages 42 may vary depending upon the particular application. The plurality of plates 40 provide a large surface contact area for the arc gases 30 flowing in parallel therealong.

A second type of plate (FIG. 3) within the gas channel comprises a filter plate 44 that is disposed proximate an exhaust outlet side 46 of the gas channel. The filter plate 44 is aligned in a substantially perpendicular orientation relative to the predominant flow direction 41 (FIG. 2) of the arc gases 30. Although a single filter plate is illustrated and described herein, it is to be appreciated that more than one filter plate may be included. The filter plate 44 includes a plurality of apertures 48. The plurality of apertures 48 may be arranged in numerous contemplated arrangements. In the illustrated embodiment, the plurality of apertures 48 are arranged in a plurality of rows 50. In such an embodiment, the plurality of rows 50 are aligned with at least one passage of the plurality of gas flow passages 42. Regardless of the precise arrangement of the plurality of gas flow passages 42 and the plurality of apertures 48, the features are configured to reduce the restriction of flow of the arc gases 30. In one embodiment, the total area of the plurality of gas flow passages 42 is substantially equal to the total area of the plurality of apertures 48.

Advantageously, the plates described in detail above, whether employed independently or in combination, de-pressurize the arc gases 30, remove the electric potential from them and have only hot gas exiting the plurality of gas channels 36. The modular gas exhaust assembly 16 generally provides an extension of the arc chute 28 and enables flexible customization of the assembly with various circuit breakers. This enables an upgrade in short circuit rating, for example.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A modular gas exhaust assembly for a circuit breaker having a plurality of arc chutes each having an associated expulsion location comprising:
a plurality of modular exhaust casings; and
a plurality of gas channels, each channel defined by one of the plurality of modular exhaust casings, the plurality of modular exhaust casings each configured to be removably coupled to at least one of the arc chute expulsion locations of the plurality of arc chutes, wherein the number of the plurality of gas channels is equal to the number of a plurality of poles of the circuit breaker, each gas channel aligned with a respective pole and configured to separately exhaust arc gases from the respective pole of the circuit breaker.

2. The modular gas exhaust assembly of claim 1, further comprising at least one plate disposed within each of the plurality of gas channels.

3. The modular gas exhaust assembly of claim 2, wherein the at least one plate comprises a plurality of apertures and is aligned perpendicularly to a gas flow direction.

4. The modular gas exhaust assembly of claim 2, wherein the at least one plate is aligned parallel to a gas flow direction.

5. The modular gas exhaust assembly of claim 4, wherein the at least one plate comprises a plurality of plates that define a plurality of gas flow passages therebetween.

6. The modular gas exhaust assembly of claim 1, further comprising:
a plurality of plates disposed within each of the plurality of gas channels and aligned parallel to a gas flow direction, wherein the plurality of plates define a plurality of gas flow passages therebetween; and
a plurality of filter plates each having a plurality of apertures and aligned perpendicularly to the gas flow direction, each of the plurality of gas channels having an exhaust outlet side, wherein one of the plurality of filter plates is disposed proximate the exhaust outlet side of each of the plurality of gas channels.

7. The modular gas exhaust assembly of claim 6, wherein the plurality of apertures of the plurality of filter plates are arranged in a plurality of rows, each of the plurality of rows aligned with a respective passage of the plurality of gas flow passages.

8. The modular gas exhaust assembly of claim 6, wherein the plurality of plates and the plurality of filter plates are formed of a metallic material.

9. The modular gas exhaust assembly of claim 1, further comprising a circuit breaker cassette and a mounting plate fixed to the circuit breaker cassette, wherein each of the plurality of modular exhaust casings are removably mounted to the mounting plate with a plurality of mechanical fasteners.

10. The modular gas exhaust assembly of claim 9, the mounting plate having a deflector portion configured to route arc gas from the plurality of arc chutes to the plurality of gas channels for additional heat dissipation of arc gas within the plurality of gas channels.

11. The modular gas exhaust assembly of claim 1, wherein the plurality of gas channels are insulated from each other.

12. A circuit breaker assembly comprising:
a circuit breaker;
a plurality of arc chutes defined by the circuit breaker, each of the plurality of arc chutes aligned with a pole of the circuit breaker and having an expulsion location to exhaust an arc gas from the circuit breaker;
a plurality of modular exhaust casings;
a plurality of gas channels, each channel defined by one of the plurality of modular exhaust casings, each of the plurality of modular exhaust casings configured to be removably coupled proximate the expulsion location of at least one of the plurality of arc chutes, each of the plurality of gas channels aligned with a respective pole of the circuit breaker and having an exhaust outlet side to separately exhaust arc gases from the respective pole of the circuit breaker; and
a plurality of filter plates having a plurality of apertures and aligned perpendicularly to a gas flow direction, wherein each of the plurality of filter plates are disposed proximate the exhaust outlet side of each of the plurality of gas channels.

13. The circuit breaker assembly of claim 12, further comprising a plurality of plates disposed within each of the plurality of gas channels and aligned parallel to the gas flow direction, wherein the plurality of plates define a plurality of gas flow passages therebetween.

14. The circuit breaker assembly of claim 13, wherein the plurality of apertures of each of the plurality of filter plates are arranged in a plurality of rows, each of the plurality of rows aligned with a respective passage of the plurality of gas flow passages defined by the plurality of plates.

15. The circuit breaker assembly of claim 14, wherein the plurality of plates and the plurality of filter plates are formed of a metallic material.

16. The circuit breaker assembly of claim 12, further comprising a circuit breaker cassette having a mounting plate fixed thereto, wherein each of the plurality of modular exhaust casings are removably mounted to the mounting plate with a plurality of mechanical fasteners removably engaged thereto.

17. The circuit breaker assembly of claim 16, the mounting plate having a deflector portion configured to route arc gas from the plurality of arc chutes to the plurality of gas channels for additional heat dissipation of arc gases within the plurality of gas channels.

18. The circuit breaker assembly of claim 12, wherein each of the plurality of gas channels are insulated from each other.

19. A method of exhausting an arc gas from a circuit breaker comprising:
extending a protected interior volume of the circuit breaker with a plurality of modular exhaust casings located proximate an expulsion location of at least one arc chute; and
allowing additional cooling and de-ionization of the arc gas within a plurality of gas channels defined by the plurality of modular exhaust casings.

20. The method of claim 19, further comprising selectively determining the number of the plurality of modular exhaust casings to be equal to the number of poles of the circuit breaker.
